(19) United States
(12) Patent Application Publication
(10) Pub. No.: US 2024/0320696 A1
(43) Pub. Date: Sep. 26, 2024

(54) SYSTEM AND METHOD FOR CONDUCTING ANONYMOUS INTELLIGENT SURVEYS

(71) Applicant: Amod Ashok DANGE, Mountain View, CA (US)

(72) Inventor: Amod Ashok DANGE, Mountain View, CA (US)

(21) Appl. No.: 18/216,713

(22) Filed: Jun. 30, 2023

Related U.S. Application Data
(60) Provisional application No. 63/492,240, filed on Mar. 26, 2023.

(51) Int. Cl. G06Q 30/0203; G06Q 30/0207; G06Q 30/0217

(52) U.S. Cl. CPC G06Q 30/0203; G06Q 30/0215; G06Q 30/0217; G06Q 50/265

(57) ABSTRACT

A system and method for conducting anonymous intelligent surveys. The system is configured for creating ontologies by accepting a set of inputs corresponding to each domain from a set of domains, associating the set of domains with a set of related ontologies based on the set of inputs, and composing Resource Description Framework (RDF) triples comprising data entities in subject-predicate-object structures based on the set of related ontologies. The system is configured for registering a set of users by receiving demographic information sets of preferences corresponding to each user from the set of users. The system is configured for registering a set of organizations and provisioning an organization, from the set of organizations, to generate a questionnaire, and selecting candidate respondents to a survey from the one or more surveys by capturing responses from the candidate respondents.

### CROSS-REFERENCE TO RELATED APPLICATIONS

The present application claims priority from U.S. Provisional Application No. 63/492,240 titled “Method of conducting anonymized structured-data surveys” and dated Mar. 26, 2023.

### TECHNICAL FIELD

The present subject matter described herein, in general, relates to a system and a method for conducting intelligent surveys. More specifically, the present subject matter discloses the system and method for conducting anonymized intelligent surveys.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology, Traditionally, software applications require people to provide their identity as well as personal information in order to get themselves registered on an application. However, this practice has resulted in several undesirable outcomes. People end up creating a different profile for each application such as Gmail™, Twitter™, Amazon™ etc. As the number of profiles increases, it becomes difficult to manage these profiles. On an average an online user has 7.6 social media accounts. Many of these online profiles are created using fake identities. An estimated 30% of profiles on social media are based on fake identities. Moreover, in the existing social networking platforms, there is no barrier to keep a user from creating a profile that corresponds to someone other than themselves. Furthermore, users don't always have control over their online profile's visibility to others within or outside of their own human network. User privacy is also at risk as different applications have different privacy standards.

Additionally, software applications often collect more personal information from users than is needed to provide the application's functionality. This information may be misused by these software applications for targeted advertising. Generally, the information captured by these software applications is used to run advertising campaigns targeted at social media audience cohorts whose attributes are extrapolated from their online activity. This may include the web searches they perform, the content they consume, and the social media posts they engage with. This method poses several limitations. The search and social media platforms that track users' activity often have access to users' identity. Although social media platforms mask their users' identity from advertisers and developers, there is a massive burden on the social media platforms to protect their users' identity and keep it hidden from advertisers and developers at all times. More importantly, users' identity is not hidden from the platforms themselves, thereby creating an exception for the platforms in respect of the rule applied to the advertisers that no single entity should have access to people's identity as well as activity.

Furthermore, ecommerce businesses such as Amazon™ and eBay™ capture users' activity data on one product platform and apply it to other products using shared cookies. Users often have no visibility into which businesses have access to what part of their personal information. The collection of users' attributes and preferences is a one-way flow. Platforms gather users' activity data and retain it permanently. Users have no control over their own activity data once it has been captured by the platform. Moreover, users do not use platforms with the intention of providing the platforms with their personal information. Therefore, finding themselves to be the target of advertisements based on specific personal attributes detected by platforms makes them feel violated. Platforms algorithmically interpret people's engagement data to deduce their attributes and preferences. Hence, there is a level of abstraction between users' actual attributes and preferences, and those targeted by businesses in their advertising campaigns on platforms.

Also, there is an inherent limit to how deeply businesses can understand a user's real attributes and preferences. Users do not know how much of their personal information and preferences that they did not share with anyone intentionally is stored and shared by platforms. This causes widespread anxiety and stress among people.

Furthermore, users' identities on the internet are stored on a network server. The server requires resources to host users' identities, keep them secure, and perform regular maintenance. Users do not always have control over their digital identity stored on the server. Every identity on the server does not necessarily correspond to a unique person. In the existing art there is no known way to prevent the storage of identities. People need to manage credentials to access their own identities on the servers.

To address some of the above issues and to manage credentials of a multitude of applications, Single Sign-On mechanisms such as OAUTH and SAML are used. The Single Sign-on mechanism allows applications to use tokens and transfer the burden of authentication to federated identity providers such as Google™ and Apple™, During the handoff from a third-party authentication to the client application, typically, personally identifiable information such as name, email, profile photo, etc., is also shared with the client application in an opt-out manner. This reintroduces vulnerabilities in the client application and negates the separation of identity authentication in the first place. Even if no personally identifiable information is handed off to the client application, the third-party authentication system is still susceptible to the same security challenges and all weaknesses are passed on downstream.

Another technique adopted for security is two-factor authentication. There are several ways by which two-factor authentication can be enabled in order to provide an additional layer of security. One method is by sending a code over email or text message. This assumes that the client application has access to the user's email or phone number which, if true, also means that they have the ability to determine the user's identity with relative ease. Additionally, if the user's phone or email are compromised, this system works in favor of the perpetrator and further injures the victim. Another method of two-factor authentication is enabled by generating a code via a separate authentication application. It assumes that the user has control over that authentication application. If the user loses access to the authenticator application, they lose access to their identity manager. Yet another method of two-factor authentication is enabled by having the user remember a pass-phrase, a visual shape, or answers that they made up for a number of personal questions, or any variant thereof. This usually results in an unreasonable barrier for the user and a bad user experience.

Furthermore, historically personalized software applications require users to set a username (unique string, email, or phone number) and a password, in order to have secure access to a personalized account. In case the username is the user's email or phone number, the user's identity is revealed to the application. If the username is a string, the application still requires the user's email or phone number to enable the user to reset the password if it is lost.

Emails and phone numbers are not private. Unlisted phone numbers and email addresses can be traced back to their owners with relative ease. When people register on a service using their email address or phone number, their identity becomes vulnerable to attacks. History indicates that it is almost certain that every user's personal information will be leaked at some point. In recent times, there are an increasing number of cases, where personal data of millions of social media users has been leaked and posted online. And since their accounts with all services are tied to either an email, or a phone number, or both, when data from multiple services are compromised, leaked information can be combined, resulting in further injury to the users whose data is leaked.

The world's most powerful technology companies have utterly failed to protect people's privacy. This is primarily because they are still continuing to use peoples' email or phone numbers to uniquely identify them within their systems. While only the most high-profile data breaches get reported, a vast majority of data breaches go unreported. Overall, there is overwhelming evidence demonstrating that online privacy does not exist in any meaningful way. Thus, clearly the most effective way for any company to prevent their users' privacy from being breached is to not have their systems access their users' identities in the first place.

The privacy issues get worse when conducting a survey. The common challenges in designing and conducting surveys include identifying and qualifying candidate survey respondents, maintaining the privacy and confidentiality of the respondents, incentivizing candidate survey respondents to respond, ensuring that the respondents' responses are authentic, compiling response data accurately and ensuring internal consistency, removing redundancy across different surveys, and making inferences using data gathered in the same survey and across different surveys.

Thus, there is a long-felt need for a system and method of conducting anonymous intelligent surveys.

### SUMMARY

This summary is provided to introduce concepts related to a system and a method conducting anonymous intelligent data surveys. The concepts are further described below in the detailed description. This summary is not intended to identify essential features of the claimed subject matter nor is it intended for use in determining or limiting the scope of the claimed subject matter.

In one implementation, a method for conducting anonymous intelligent surveys, is illustrated in accordance with an embodiment of the invention. The method comprising steps of creating ontologies by accepting a set of inputs corresponding to each domain from a set of domains, associating the set of domains with a set of related ontologies based on the set of inputs, and composing Resource Description Framework (RDF) triples comprising data entities in subject-predicate-object structures based on the set of related ontologies. The method further comprises steps of registering a set of users by creating an anonymized people registry corresponding to a set of users, wherein each user from the set of users is unique, receiving demographic information corresponding to each user from the set of users, and receiving sets of preferences corresponding to each user from the set of users. The method further comprises steps of registering a set of organizations by creating an organization registry corresponding to a set of organizations, receiving domain information corresponding to each organization from the set of organizations, and assigning at least one target domain to the organization in the organization registry based on the domain information. The method further comprises steps of provisioning an organization, from the set of organizations, to generate a questionnaire by providing an interface for the organization to create a questionnaire by selecting one or more domains, from the set of domains, associated with the questionnaire, and generating sets of ontology-based questions, wherein the questions are generated based on one or more inputs, corresponding to the RDF triples, received from the organization. The method further comprises steps of building one or more surveys, corresponding to the organization, wherein each survey comprises at least one set of ontology-based questions from the sets of ontology-based questions, and providing an interface for the organization to configure a target set of non-personally identifiable parameters. The method further comprises steps of selecting candidate respondents to a survey from the one or more surveys by identifying a set of target users, from the set of users, based on comparison of the target set of non-personally identifiable parameters with the demographic information and the sets of preferences associated with each of the set of users, inviting the set of target users to take the survey, and enabling the set of target users to access the survey. The method further comprises steps of capturing responses from the set of target users by recording responses received from at least one target user, from the set of target users, corresponding to at least one ontology-based question from the at least one set of ontology-based questions associated with the survey, transforming the responses into ontology-based RDF triples, inferring one or more facts based on the ontology-based RDF triples, and determining a confidence level corresponding to the one or more facts based on a set of predefined parameters. The method further comprises steps of applying the one or more facts to the remaining questions in the survey, to automatically answer the remaining questions when applicable, or update the remaining questions, when the confidence level is above a predefined threshold level. The method further comprises steps of enabling the user to preview and to approve or reject the automatically generated answer, or generating a new question for seeking further clarification, when the confidence level is below the predefined threshold level.

In one implementation, a system for conducting anonymous intelligent surveys, is illustrated in accordance with an embodiment of the invention. The system comprises a processor and a memory coupled to the process. The processor is configured to execute program instructions stored in the memory for creating ontologies by accepting a set of inputs corresponding to each domain from a set of domains, associating the set of domains with a set of related ontologies based on the set of inputs, and composing Resource Description Framework (RDF) triples comprising data entities in subject-predicate-object structures based on the set of related ontologies. The processor is configured to execute program instructions stored in the memory for registering a set of users by creating an anonymized people registry corresponding to a set of users, wherein each user from the set of users is unique, receiving demographic information corresponding to each user from the set of users, and receiving sets of preferences corresponding to each user from the set of users. The processor is configured to execute program instructions stored in the memory for registering a set of organizations by creating an organization registry corresponding to a set of organizations, receiving domain information corresponding to each organization from the set of organizations, and assigning at least one target domain to the organization in the organization registry based on the domain information. The processor is configured to execute program instructions stored in the memory for provisioning an organization, from the set of organizations, to generate a questionnaire by providing an interface for the organization to create a questionnaire by selecting one or more domains, from the set of domains, associated with the questionnaire, and generating sets of ontology-based questions, wherein questions are generated based on one or more inputs, corresponding to the RDF triples, received from the organization. The processor is configured to execute program instructions stored in the memory for building one or more surveys, corresponding to the organization, wherein each survey comprises at least one set of ontology-based questions from the sets of ontology-based questions, and providing an interface for the organization to configure a target set of non-personally identifiable parameters. The processor is configured to execute program instructions stored in the memory for selecting candidate respondents to a survey from the one or more surveys by identifying a set of target users, from the set of users, based on comparison of the target set of non-personally identifiable parameters with the demographic information and the sets of preferences associated with each of the set of users, inviting the set of target users to take the survey, and enabling the set of target users to access the survey. The processor is configured to execute program instructions stored in the memory for capturing responses from the set of target users by recording responses received from at least one target user, from the set of target users, corresponding to at least one ontology-based question from the at least one set of ontology-based questions associated with the survey, transforming the responses into ontology-based RDF triples, inferring one or more facts based on the ontology-based RDF triples, and determining a confidence level corresponding to the one or more facts based on a set of predefined parameters. The processor is configured to execute program instructions stored in the memory for applying the one or more facts to the remaining questions in the survey, to automatically answer the remaining questions when applicable, or update the remaining questions, when the confidence level is above a predefined threshold level. The processor is configured to execute program instructions stored in the memory for enabling the user to preview and to approve or reject the automatically generated answer, or generating a new question for seeking further clarification, when the confidence level is below the predefined threshold level.

### BRIEF DESCRIPTION OF DRAWINGS

The detailed description is described with reference to the accompanying Figures. The same numbers are used throughout the drawings to refer like features and components.

FIG. 1 illustrates a network implementation 100 of a system 101 to conduct an anonymous intelligent survey, in accordance with an embodiment of the present disclosure.

FIG. 2 illustrates components of the system 101 to conduct the anonymous intelligent survey, in accordance with an embodiment of the present disclosure.

FIG. 3 illustrates a method 300 to conduct anonymous intelligent survey, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

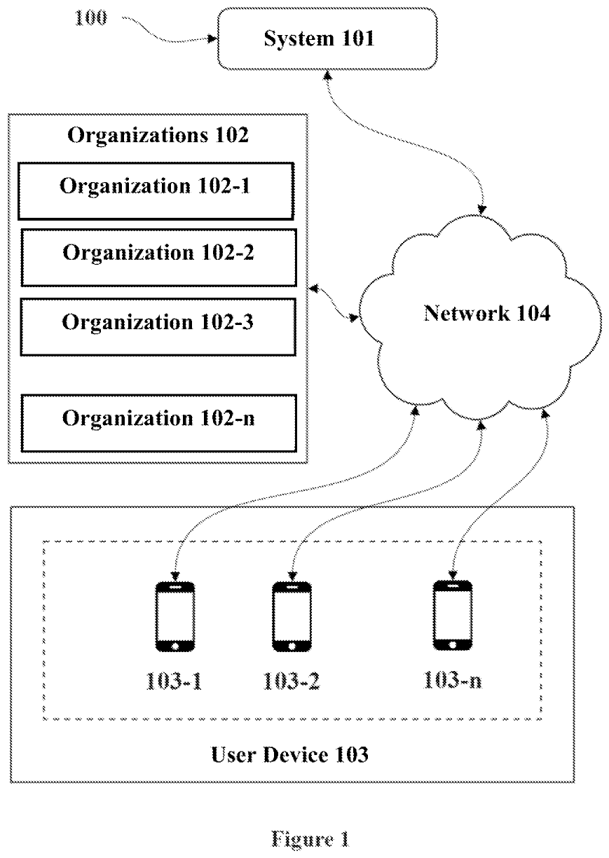

Referring to FIG. 1, implementation 100 of system 101 for conducting anonymous intelligent surveys is illustrated, in accordance with an embodiment of the present subject matter. In one embodiment, the system 101 may comprise a processor and a memory. Further, the system 101 may be connected to user devices and Applications through a network 104. It may be understood that the system 101 may be communicatively coupled with multiple users through one or more User devices 103-1, 103-2, 103-3 . . . , 103-n and Organizations 102-1, 102-2, 102-3 . . . , 102-n collectively referred to as a user device 103 and Organizations 102.

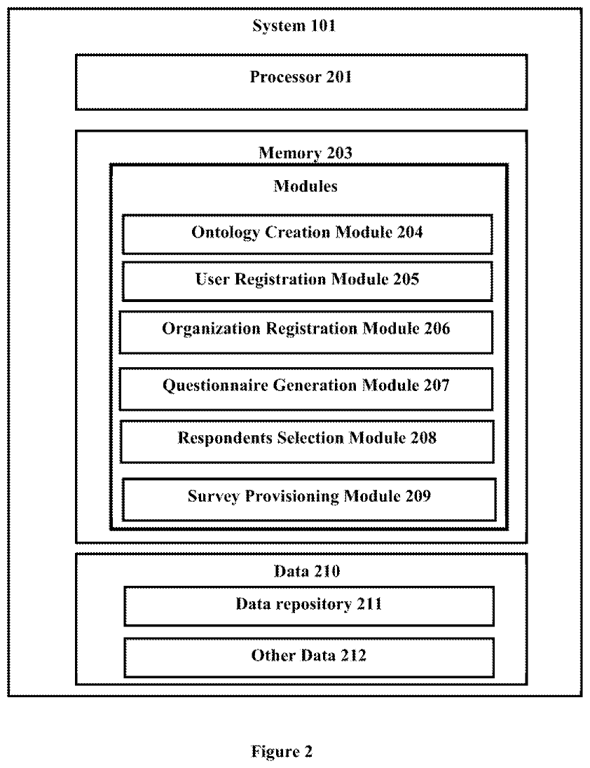

In one embodiment, the network 104 may be a cellular communication network used by user devices 103 such as mobile phones, tablets, or a virtual device. In one embodiment, the cellular communication network may be the Internet. Further, the user device 103 may be any electronic device, communication device, image capturing device, machine, software, automated computer program, a robot or a combination thereof. The system 101 may be configured to register users over the system 101. Further, the system may be configured to authenticate the user, each time the user makes a request to access the system 101. In one embodiment, the user devices 103 are enabled with biometric scanning capabilities for enabling the user to access the system 101 after biometric authentication. The user registration process is further illustrated with the block diagram in FIG. 2.

In one embodiment, the user devices 103 may support communication over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. The aforementioned user devices 103 and network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

Further the Organization 102 may be any entity with any product or service base including but not limited to networking platforms, media platforms, messaging platforms, ecommerce platforms, or any other application platform. The Organization 102 may be any ecommerce platform which requires surveys in order to understand market requirements and promote their products and services.

Referring now to FIG. 2, various components of the system 101 are illustrated, in accordance with an embodiment of the present subject matter. As shown, the system 101 may include at least one processor 201 and a memory 203. The memory consists of a set of modules. The set of modules may include an ontology creation module 204, a user registration module 205, an organization registration module 206, a questionnaire generation module 207, a respondents selection module 208, survey provisioning module 209. In one embodiment, the at least one processor 201 is configured to fetch and execute computer-readable instructions, stored in the memory 203, corresponding to each module.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The data 210 may comprise a data repository 211, and other data 212. The other data 212 amongst other things, serves as a repository for storing data processed, received, and generated by one or more components and programmed instructions.

The working of the system 101 will now be described in detail referring to FIGS. 1 and 2.

In one embodiment, the processor 201 may be configured for executing programmed instructions corresponding to the ontology creation module 204 for creating ontologies and ontology data models. The ontology data model corresponds to a formal description of knowledge represented in the form of a set of concepts associated with a domain and also the relationships that hold between the set of concepts. To enable such a description, the ontology creation module 204 is configured to formally specify components such as individuals (instances of objects), classes, attributes and relations as well as restrictions, rules and axioms.

Thus, ontology data models introduce a sharable and reusable knowledge representation as well as add new knowledge about the domain. The ontology data models can be applied to a set of individual facts to create a knowledge graph. The knowledge graph is a collection of entities. The types and the relationships between entities are expressed by nodes and edges between these nodes. By describing the structure of the knowledge in a domain, the ontology data model sets the stage for the knowledge graph to capture the data in it. In place of ontology data models, there are other methods that use formal specifications for knowledge representation such as taxonomies, thesauri, logical models, vocabularies, and topic maps.

However, unlike taxonomies or relational database schemas, for example, ontologies express relationships and at the same time also enable users to link multiple concepts to other concepts in a variety of ways.

For the purpose of creating ontologies, the ontology creation module 204 is configured for accepting a set of inputs corresponding to each domain from a set of domains. The domain from the set of domains may correspond to movies, consumer electronics, apparel, shoes, and the like. Each domain may be distinctly identifiable from another. Further, the set of inputs may comprise a set of concepts and a set of categories corresponding to each domain. For example, the set of concepts may correspond to product, brand, customer, order, payment, shipping, and the like. The set of categories may correspond to “dress shoes”, “casual shoes”, “walking shoes”, “running shoes” and the like. The set of inputs further comprise a set of properties and correlations between the set of properties associated with each domain. The set of properties and correlation between the set of properties may be represented as below:

### Properties:

Product:
   hasCategory
   hasBrand
   hasSubbrand
   hasModelnumber
   hasPrice

Further, the ontology creation module 204 is configured for associating the set of domains with a set of related ontologies based on the set of inputs. Further, the ontology creation module 204 is configured for composing Resource Description Framework (RDF) triples comprising data entities in subject-predicate-object structures based on the set of related ontologies. The Resource Description Framework (RDF) triples together to form an RDF triplestore engine. The RDF triplestore engines support the ontologies and the associated optional schema models. The ontologies allow for a formal description of the data. They specify both object classes and relationship properties, as well as their hierarchical order. When a set of triples are joined together, they form a knowledge graph, where the subjects and objects are the nodes and the predicates are interpreted as edges. The knowledge graph comprises curated ontologies. The below table 1 represents RDF triples for an e-commerce domain.

TABLE 1
RDF Triples for a specific domain
Domain: Shoes

| Sr. No. | Subject | Predicate | Object |
|---|---|---|---|
| 1 | product | hasCategory | shoes |
| 2 | product | hasBrand | Nike |
| 3 | product | hasSubbrand | Air Max |
| 4 | product | hasModelnumber | 270 |
| 5 | product | hasPrice | USD 100 |
| . . . | | | |

Once the ontologies are created, the processor 201 may be configured for executing programmed instructions corresponding to user registration module 205 for registering a user over the system 101. For the purpose of registration, a user may send a request for registration to the system 101 from the user device 103. Once the request is received, the processor 201 may receive a set of biometric samples of the user, corresponding to one or more biometric factors. The one or more biometric factors may correspond to fingerprint, face, voice, retina, and palm vein. It must be understood that the one or more biometric factors are not limited only to fingerprint, face, voice, retina, and palm vein. Any other biometric factors which can uniquely identify a user may be collected from the user. The set of biometric samples may be captured by the user device 103 and sent to the system 101 for registration.

Further, the processor 201 may be configured for executing programmed instructions corresponding to user registration module 205 for creating an anonymized people registry corresponding to a set of users, wherein each user from the set of users is unique. Further, the processor 201 may be configured for executing programmed instructions corresponding to user registration module 205 for receiving demographic information corresponding to each user from the set of users. The demographic information may comprise nationality, gender, age-range, and other non-personally identifiable information. The demographic information may be captured by providing each user an interface, through the user device 101, to scan a government-issued identification document, extracting demographic information from the identification document, and storing the demographic information on a user device 101. The demographic information may be stored in an encrypted format.

Further, the processor 201 may be configured for executing programmed instructions corresponding to user registration module 205 for receiving sets of preferences corresponding to each user from the set of users, wherein the sets of preferences are non-personally identifiable, wherein each set of preferences is assigned one or more domains.

Furthermore, the processor 201 is configured to execute program instructions corresponding to the user registration module 205 for registering a set of users. For the purpose of registering the set of users, the user registration module 205 is configured for creating an anonymized people registry corresponding to a set of users, wherein each user from the set of users is unique. Further, the user registration module 205 is configured for receiving demographic information corresponding to each user from the set of users. Further, the user registration module 205 is configured for receiving sets of preferences corresponding to each user from the set of users, wherein the sets of preferences are non-personally identifiable. The sets of preferences are stored on the user device 101. Further, it must be noted that each set of preferences is assigned one or more domains.

Furthermore, the processor 201 is configured to execute program instructions corresponding to the organization registration module 206 for registering a set of organizations. For this purpose, the organization registration module 206 is configured for creating an organization registry corresponding to a set of organizations. Further, the organization registration module 206 is configured for receiving domain information corresponding to each organization from the set of organizations. Finally, the organization registration module 206 is configured for assigning at least one target domain to the organization in the organization registry based on the domain information.

Furthermore, the processor 201 is configured to execute program instructions corresponding to the questionnaire generation module 207 for provisioning an organization, from the set of organizations, to generate a questionnaire. For the purpose of generating the questionnaire, the questionnaire generation module 207 is configured for providing an interface for the organization to create a questionnaire by selecting one or more domains, from the set of domains associated with the questionnaire, and generating sets of ontology-based questions composed of Semantic (RDF) triples. The questions in the sets of ontology-based questions are generated based on one or more inputs, corresponding to the RDF triples, received from the organization. Further, the questionnaire generation module 207 is configured for building one or more surveys, corresponding to the organization, wherein each survey comprises at least one set of ontology-based questions from the sets of ontology-based questions. In other words, questionnaire generation module 207 enables the organization to utilize the knowledge graph of the Semantic (RDF) triples to generate the survey.

In one embodiment, the questionnaire generation module 207 is configured for providing an interface for the organization to configure a target set of non-personally identifiable parameters. Furthermore, the processor 201 is configured to execute program instructions corresponding to the respondents selection module 208 for selecting candidate respondents to a survey from the one or more surveys. For this purpose, the respondents selection module 208 is configured for identifying a set of target users, from the set of users, based on comparison of the target set of non-personally identifiable parameters with the demographic information and the sets of preferences associated with each of the set of users. Further, the respondents selection module 208 is configured for inviting the set of target users to take the survey and enable the set of target users to access the survey.

Furthermore, the processor 201 is configured to execute program instructions corresponding to the survey provisioning module 209 for capturing responses from the set of target users by recording responses received from at least one target user, from the set of target users, corresponding to at least one ontology-based question from the at least one set of ontology-based questions associated with the survey. Further, the survey provisioning module 209 is configured for transforming the responses into ontology-based RDF triples and inferring one or more facts based on the ontology-based RDF triples. For example, the ontology-based question may correspond to a choice of beverages such as ‘does the user ‘A’ consume soft drinks?’, ‘does the user ‘A’ consume flavored drinks?’. If the answer for these questions is ‘No’, then a fact may be computed as “User ‘A’ does not consume Coke™”, “User ‘A’ does not consume Pepsi™”, where ontology-based RDF triples contain the facts that Coke™ and Pepsi™ are categorized as “soft drinks” and “flavored drinks.” Further, the survey provisioning module 209 is configured for determining a confidence level corresponding to the one or more facts based on a set of predefined parameters such as certainty of the answers provided, previous answers provided by the user, and the link. It must be noted that the ontology-based questions are highly organized and have a deep correlation with each other. As a result, inputs received from the user for an ontology-based question can be easily processed in order to extract facts and draw inferences. As a result, the answers received from the user on one or more ontology-based questions can be easily processed and accordingly inferences and facts can be drawn with minimal processing efforts. These inferences and facts can be used for automatically answering the remaining questions in the survey.

In one embodiment, an ontology-based set of questions may comprise questions arranged in a hierarchical tree data structure, where the trunk node represents the first question and the leaf nodes represent the last question in the hierarchical tree data structure. As the user answers different questions, the user traverses from the trunk node to the leaf node.

In one embodiment, when the confidence level is above a predefined threshold level, the survey provisioning module 209 is configured for applying the one or more facts to the remaining questions in the set of questions, to automatically answer the remaining questions when applicable, or update the remaining questions. In the above example, the remaining questions may correspond to “does user ‘A’ consume Dr Pepper?” which would be automatically answered as ‘No’ without bothering the user A with additional questions about Dr Pepper.

However, when the confidence level is below the predefined threshold level, the survey provisioning module 209 is configured for enabling the user A to preview and to approve or reject the automatically generated answer, or generating a new question for seeking further clarification.

In one embodiment, once the survey responses are received from the user, the findings from the survey responses are injected back into the knowledge graph of the RDF triples. As a result, the knowledge graph is updated with the latest trends and user preferences giving it more veracity (credibility), and at the same time track the changes that have occurred since the last time the Knowledge Graph was updated. This creates a feedback loop that continuously improves the knowledge graph. Thus, the semantic RDF triples are coupled with the human-trained knowledge graph, which results in a self-learning model of real-time world comprehension hereinafter referred to as a self-learning RDF triplestore. In other words, the responses from the target user are processed to compute findings. The findings are then injected back into the knowledge graph. The knowledge graph is updated with the latest findings. Over time, the feedback loop generated by tracking and recording changes in the knowledge graph results in a self-learning RDF triplestore.

In one embodiment, the survey provisioning module 209 is further configured for optimizing at least one survey from the one or more surveys based on the responses received from the at least one target user corresponding to the questionnaire associated with a previously conducted survey by identifying a set of questions that are common between the previously conducted survey and the at least one survey from the one or more surveys and optimizing the at least one survey from the one or more surveys by automatically answering the set of questions that are common, from the at least one survey. For this purpose, the survey provisioning module 209 is configured to identify the relationship between any two or more responses from one or more previous surveys and generate inferences from the relationship between the two or more responses. Further, the survey provisioning module 209 is configured to determine a confidence level corresponding to the one or more inferences based on a set of predefined parameters. Furthermore, when the confidence level is above a predefined threshold level, the survey provisioning module 209 is configured to apply the one or more inferences to remaining questions in the survey, to automatically answer the remaining questions when applicable, or update the remaining questions. Furthermore, when the confidence level is below the predefined threshold level, the survey provisioning module 209 is configured to enable the user to preview and to approve or reject the automatically generated answer or generating a new question for seeking further clarification.

In one embodiment, the survey provisioning module 209 is further configured for incentivizing the set of target users by offering anonymity and privacy to the set of target users for participating in the surveys, and optionally offering the set of target users a portion of fees paid by the organization conducting the survey.

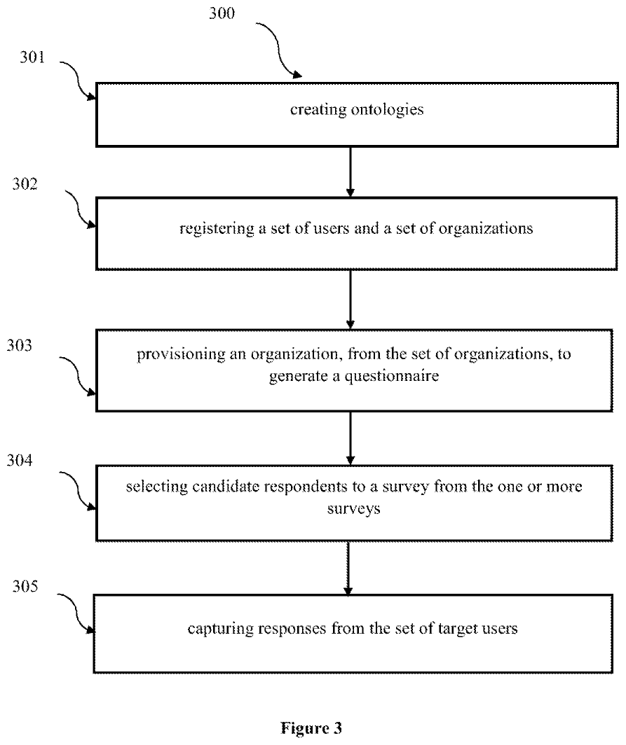

Now referring to FIG. 3, a method 300 for affixing the signature using biometric authentication is illustrated, in accordance with an embodiment of the present subject matter.

At step 301, the processor 201 may be configured for executing programmed instructions for creating ontologies. For the purpose of creating ontologies, the processor 201 is configured for accepting a set of inputs corresponding to each domain from a set of domains. The domain from the set of domains may correspond to movies, consumer electronics, apparel, shoes, and the like. Each domain may be distinctly identifiable from another. Further, the set of inputs may comprise a set of concepts and a set of categories corresponding to each domain. For example, the set of concepts may correspond to product, brand, customer, order, payment, shipping, and the like. The set of inputs further comprise a set of properties and correlations between the set of properties associated with each domain. Further, the processor 201 is configured for associating the set of domains with a set of related ontologies based on the set of inputs. Further, the processor 201 is configured for composing Resource Description Framework (RDF) triples comprising data entities in subject-predicate-object structures based on the set of related ontologies.

At step 302, the processor 201 may be configured for executing programmed instructions for registering a user over the system 101. For the purpose of registration, a user may send a request for registration to the system 101 from the user device 103. Once the request is received, the processor 201 may receive a set of biometric samples of the user, corresponding to one or more biometric factors. The one or more biometric factors may correspond to fingerprint, face, voice, retina, and palm vein. It must be understood that the one or more biometric factors are not limited only to fingerprint, face, voice, retina, and palm vein. Any other biometric factors which can uniquely identify a user may be collected from the user. The set of biometric samples may be captured by the user device 103 and sent to the system 101 for registration.

Further, the processor 201 may be configured for executing programmed instructions for creating an anonymized people registry corresponding to a set of users, wherein each user from the set of users is unique. Further, the processor 201 may be configured for executing programmed instructions corresponding to user registration module 205 for receiving demographic information corresponding to each user from the set of users. The demographic information may comprise nationality, gender, age-range, and other non-personally identifiable information. The demographic information may be captured by providing each user an interface, through the user device 101, to scan a government-issued identification document, extracting demographic information from the identification document, and storing the demographic information on a user device 101. The demographic information may be stored in an encrypted form.

Further, the processor 201 may be configured for executing programmed instructions for receiving sets of preferences corresponding to each user from the set of users, wherein the sets of preferences are non-personally identifiable, wherein each set of preferences is assigned one or more domains. Further, the processor 201 is configured to execute program instructions for registering a set of users. Further, the processor 201 may be configured for executing programmed instructions for receiving demographic information corresponding to each user from the set of users. Further, the processor 201 may be configured for executing programmed instructions for receiving sets of preferences corresponding to each user from the set of users, wherein the sets of preferences are non-personally identifiable. The sets of preferences are stored on the user device 101. Further, it must be noted that each set of preferences is assigned one or more domains.

Furthermore, the processor 201 may be configured for executing programmed instructions for registering a set of organizations. For this purpose, the processor 201 may be configured for executing programmed instructions for creating an organization registry corresponding to a set of organizations. Further, the processor 201 may be configured for executing programmed instructions for receiving domain information corresponding to each organization from the set of organizations. Finally, the processor 201 may be configured for executing programmed instructions for assigning at least one target domain to the organization in the organization registry based on the domain information.

At step 303, the processor 201 may be configured for executing programmed instructions for provisioning an organization, from the set of organizations, to generate a questionnaire. For the purpose of generating the questioners, the processor 201 may be configured for executing programmed instructions for providing an interface for the organization to create a questionnaire by selecting one or more domains, from the set of domains associated with the questionnaire, and generating sets of ontology-based questions. The sets of ontology-based questions are generated based on one or more inputs, corresponding to the RDF triples, received from the organization. Further, the processor 201 may be configured for executing programmed instructions for building one or more surveys, corresponding to the organization, wherein each survey comprises at least one set of ontology-based questions from the sets of ontology-based questions. Further, the processor 201 may be configured for executing programmed instructions for providing an interface for the organization to configure a target set of non-personally identifiable parameters.

At step 304, the processor 201 may be configured for executing programmed instructions for selecting candidate respondents to a survey from the one or more surveys. For this purpose, the processor 201 may be configured for executing programmed instructions for identifying a set of target users, from the set of users, based on comparison of the target set of non-personally identifiable parameters with the demographic information and the sets of preferences associated with each of the set of users. Further, the processor 201 may be configured for executing programmed instructions for inviting the set of target users to take the survey and enable the set of target users to access the survey.

At step 305, the processor 201 may be configured for executing programmed instructions for capturing responses from the set of target users by recording responses received from at least one target user, from the set of target users, corresponding to at least one ontology-based question from the at least one set of ontology-based questions associated with the survey. Further, the processor 201 may be configured for executing programmed instructions for transforming the responses into ontology-based RDF triples and inferring one or more facts based on the ontology-based RDF triples. Further, the processor 201 may be configured for executing programmed instructions for determining a confidence level corresponding to the one or more facts based on a set of predefined parameters such as certainty of the answers provided, previous answers provided by the user and the link. In one embodiment, when the confidence level is above a predefined threshold level, the processor 201 may be configured for executing programmed instructions for applying the one or more facts to the remaining questions in the survey, to automatically answer the remaining questions when applicable, or update the remaining questions.

However, when the confidence level is below the predefined threshold level, the processor 201 may be configured for executing programmed instructions for enabling the user A to preview and to approve or reject the automatically generated answer, or generating a new question for seeking further clarification.

Although implementations for the system 101 and the method 300 for conducting anonymous intelligent surveys, have been described in language specific to structural features and methods, it must be understood that the claims are not limited to the specific features or methods described. Rather, the specific features and methods are disclosed as examples of implementations for the system 101 and the method 300 for conducting anonymous intelligent surveys.

1. A method of conducting anonymous intelligent surveys, the method comprising steps of:
creating ontologies by
accepting a set of inputs corresponding to each domain from a set of domains, wherein the set of inputs comprise a set of concepts and a set of categories corresponding to each domain, wherein the set of inputs further comprise a set of properties and correlations between the set of properties associated with each domain,
associating the set of domains with a set of related ontologies based on the set of inputs, and
composing Resource Description Framework (RDF) triples comprising data entities in subject-predicate-object structures based on the set of related ontologies, wherein the RDF triples constitute a knowledge graph;
registering a set of users by
creating an anonymized people registry corresponding to a set of users, wherein each user from the set of users is unique,
receiving non-personally identifiable demographic information corresponding to each user from the set of users, and
receiving sets of preferences corresponding to each user from the set of users, wherein the sets of preferences are non-personally identifiable, wherein each set of preferences is assigned one or more domains;
registering a set of organizations by
creating an organization registry corresponding to a set of organizations,
receiving domain information corresponding to each organization from the set of organizations, and
assigning at least one target domain to the organization in the organization registry based on the domain information;
provisioning an organization, from the set of organizations, to generate a questionnaire by
providing an interface for the organization to create a questionnaire by
selecting one or more domains, from the set of domains, associated with the questionnaire, and
generating sets of ontology-based questions, wherein the questions are generated based on one or more inputs, corresponding to the RDF triples, received from the organization;
building one or more surveys, corresponding to the organization, wherein each survey comprises at least one set of ontology-based questions from the sets of ontology-based questions;
providing an interface for the organization to configure a target set of non-personally identifiable parameters;
selecting candidate respondents to a survey from the one or more surveys by
identifying a set of target users, from the set of users, based on comparison of the target set of non-personally identifiable parameters with the demographic information and the sets of preferences associated with each of the set of users,
inviting the set of target users to take the survey, and
enabling the set of target users to access the survey;
capturing responses from the set of target users by
recording responses received from at least one target user, from the set of target users, corresponding to at least one ontology-based question from the at least one set of ontology-based questions associated with the survey,
transforming the responses into ontology-based RDF triples
inferring one or more facts based on the ontology-based RDF triples,
determining a confidence level corresponding to the one or more facts based on a set of predefined parameters,
when the confidence level is above a predefined threshold level,
applying the one or more facts to the remaining questions in the survey, to
automatically answer the remaining questions when applicable, or
update the remaining questions;
when the confidence level is below the predefined threshold level,
enabling the user to preview and to approve or reject the automatically generated answer, or
generating a new question for seeking further clarification.

2. The method of claim 1 is further comprised of steps for incentivizing the set of target users by
offering anonymity and privacy to the set of target users for participating in the surveys,
optionally, offering the set of target users a portion of fees paid by the organization conducting the survey.

3. The method of claim 1, wherein, the demographic information is captured by
providing each user an interface to scan a government-issued identification document,
extracting demographic information from the identification document, wherein the demographic information comprises nationality, gender, date of birth, place of issue, and other characteristic information, and
storing the demographic information on a user device, wherein the demographic information is stored in an encrypted form.

4. The method of claim 1, wherein the sets of preferences are stored on the user device.

5. The method of claim 1 is further comprised of steps for optimizing at least one survey from the one or more surveys based on the responses received from the at least one target user corresponding to the questionnaire associated with a previously conducted survey by:
identifying a set of related questions between the previously conducted survey and the at least one survey from the one or more surveys; and
optimizing the at least one survey from the one or more surveys by removing the set of related questions, from the at least one survey,
identify the relationship between any two or more responses from one or more previous surveys,
generating inferences from the relationship between the two or more responses,
determining a confidence level corresponding to the one or more inferences based on a set of predefined parameters,
when the confidence level is above a predefined threshold level, applying the one or more inferences to remaining questions in the survey, to
automatically answer the remaining questions when applicable, or
update the remaining questions;
when the confidence level is below the predefined threshold level,
enabling the user to preview and to approve or reject the automatically generated answer
or
generating a new question for seeking further clarification.

6. The method as claimed in claim 1, wherein the responses from the target user are processed to compute findings, and the findings are injected back into the knowledge graph, wherein the knowledge graph is updated with the latest findings, wherein a feedback loop generated by tracking and recording changes in the knowledge graph over time results in a self-earning RDF triplestore.

7. A system for conducting anonymous intelligent surveys, the system comprising:
a memory; and
a processor coupled to the memory, wherein the processor is configured to execute programmed instructions stored in the memory for:
creating ontologies by
accepting a set of inputs corresponding to each domain from a set of domains, wherein the set of inputs comprise a set of concepts and a set of categories corresponding to each domain, wherein the set of inputs further comprise a set of properties and correlations between the set of properties associated with each domain,
associating the set of domains with a set of related ontologies based on the set of inputs, and
composing Resource Description Framework (RDF) triples comprising data entities in subject-predicate-object structures based on the set of related ontologies, wherein the RDF triples constitute a knowledge graph;
registering a set of users by
creating an anonymized people registry corresponding to a set of users, wherein each user from the set of users is unique,
receiving demographic information corresponding to each user from the set of users, and
receiving sets of preferences corresponding to each user from the set of users, wherein the sets of preferences are non-personally identifiable, wherein each set of preferences is assigned one or more domains;
registering a set of organizations by
creating an organization registry corresponding to a set of organizations,
receiving domain information corresponding to each organization from the set of organizations, and
assigning at least one target domain to the organization in the organization registry based on the domain information;
provisioning an organization, from the set of organizations, to generate a questionnaire by
providing an interface for the organization to create a questionnaire by
selecting one or more domains, from the set of domains, associated with the questionnaire, and
generating sets of ontology-based questions, wherein the questions are generated based on one or more inputs, corresponding to the RDF triples, received from the organization;
building one or more surveys, corresponding to the organization, wherein each survey comprises at least one set of ontology-based questions from the sets of ontology-based questions;
providing an interface for the organization to configure a target set of non-personally identifiable parameters;
selecting candidate respondents to a survey from the one or more surveys by
identifying a set of target users, from the set of users, based on comparison of the target set of non-personally identifiable parameters with the demographic information and the sets of preferences associated with each of the set of users,
inviting the set of target users to take the survey, and
enabling the set of target users to access the survey;
capturing responses from the set of target users by
recording responses received from at least one target user, from the set of target users, corresponding to at least one ontology-based question from the at least one set of ontology-based questions associated with the survey,
transforming the responses into ontology-based RDF triples
inferring one or more facts based on the ontology-based RDF triples,
determining a confidence level corresponding to the one or more facts based on a set of predefined parameters,
when the confidence level is above a predefined threshold level,
applying the one or more facts to the remaining questions in the survey, to
automatically answer the remaining questions when applicable, or
update the remaining questions:
when the confidence level is below the predefined threshold level,
enabling the user to preview and to approve or reject the automatically generated answer, or
generating a new question for seeking further clarification.

8. The system of claim 7 is further comprised of steps for incentivizing the set of target users by
offering anonymity and privacy to the set of target users for participating in the surveys,
optionally, offering the set of target users a portion of fees paid by the organization conducting the survey.

9. The system of claim 7, wherein the demographic information is captured by
providing each user an interface to scan a government-issued identification document,
extracting demographic information from the identification document, wherein the demographic information comprises nationality, gender, date of birth, place of issue, and other characteristic information, and
storing the demographic information on a user device, wherein the demographic information is stored in an encrypted form.

10. The system of claim 7, wherein the sets of preferences are stored on the user device.

11. The system of claim 7 is further comprised of steps for optimizing at least one survey from the one or more surveys based on the responses received from the at least one target user corresponding to the questionnaire associated with a previously conducted survey by
identifying a set of related questions between the previously conducted survey and the at least one survey from the one or more surveys; and
optimizing the at least one survey from the one or more surveys by removing the set of related questions, from the at least one survey,
identify the relationship between any two or more responses from one or more previous surveys,
generating inferences from the relationship between the two or more responses
determining a confidence level corresponding to the one or more inferences based on a set of predefined parameters,
when the confidence level is above a predefined threshold level, applying the one or more inferences to remaining questions in the survey, to
automatically answer the remaining questions when applicable, or
update the remaining questions;
when the confidence level is below the predefined threshold level,
enabling the user to preview and to approve or reject the automatically generated answer
or
generating a new question for seeking further clarification.

12. The system as claimed in claim 7, wherein the responses from the target user are processed to compute findings, and the findings are injected back into the knowledge graph, wherein the knowledge graph is updated with the latest findings, wherein a feedback loop generated by tracking and recording changes in the knowledge graph over time results in a self-learning RDF triplestore.
